(19) United States
(12) Patent Application Publication
(10) Pub. No.: US 2009/0173186 A1
(43) Pub. Date: Jul. 9, 2009

(54) DECLUTCHING MECHANISM

(76) Inventors: Nigel V. Spurr, Solihull (GB); Inderpal Sohanpal, West Midlands (GB); Peter J. Coleman, Worcestershire (GB)

Correspondence Address: CARLSON, GASKEY & OLDS, P.C., 400 WEST MAPLE ROAD, SUITE 350, BIRMINGHAM, MI, 48009, US

(21) Appl. No.: 12/337,927

(22) Filed: Dec. 18, 2008

(30) Foreign Application Priority Data
Jan. 7, 2008 (EP) 08250047.1

(51) Int. Cl. F16H 3/00; E05F 15/00

(52) U.S. Cl. 74/810.1; 49/139

(57) ABSTRACT

A declutching mechanism includes a chassis, a first gear rotatable relative to the chassis about a first gear axis fixed relative to the chassis, and a second gear selectively engageable with the first gear. The declutching mechanism includes an eccentric arrangement having a first shaft with a first shaft axis and a second shaft with a second shaft axis offset from the first shaft axis. The first shaft is non-rotatably fixed to the second shaft and selectively rotatably mounted in the chassis. The second gear is rotatably mounted on the second shaft. A holding feature selectively holds the eccentric arrangement in a first position. With the eccentric arrangement being held in the first position by the holding feature, the first gear and the second gear are in meshing engagement. With the eccentric arrangement being released by the holding feature, gear separating forces cause the eccentric arrangement to rotate about the first axis to a second position, thereby disengaging the first gear and the second gear.

### REFERENCE TO RELATED APPLICATION

This application claims priority to European Patent Application No. 08250047.1 filed Jan. 7, 2008.

### BACKGROUND OF THE INVENTION

The present invention relates generally to a declutching mechanism.

Declutching mechanisms are known where power being transmitted along a transmission path can be interrupted.

### SUMMARY OF THE INVENTION

The present invention relates to a specific form of declutching mechanism. The declutching mechanism includes a chassis, a first gear rotatable relative to the chassis about a first gear axis fixed relative to the chassis, and a second gear selectively engageable with the first gear. The declutching mechanism includes an eccentric arrangement having a first shaft with a first shaft axis and a second shaft with a second shaft axis offset from the first shaft axis. The first shaft is non-rotatably fixed to the second shaft and selectively rotatably mounted in the chassis. The second gear is rotatably mounted on the second shaft. A holding feature selectively holds the eccentric arrangement in a first position. With the eccentric arrangement being held in the first position by the holding feature, the first gear and the second gear are in meshing engagement. With the eccentric arrangement being released by the holding feature, gear separating forces cause the eccentric arrangement to rotate about the first axis to a second position, thereby disengaging the first gear and the second gear.

### BRIEF DESCRIPTION OF THE DRAWINGS

The invention will now be described, by way of example only, with reference to the accompanying drawings, in which:

FIG. 1 shows a declutching mechanism in an engaged position;

FIG. 2 shows the declutching mechanism of FIG. 1 in a disengaged position;

FIG. 3 shows a reverse side view of the declutching mechanism of FIG. 1 incorporated into a door opening/closing system;

FIG. 4 shows a reverse side view of the declutching mechanism of FIG. 2 incorporated into the door opening/closing system;

FIG. 5 shows part of FIG. 4;

FIGS. 6A to 7E show part of a reluctance motor of FIG. 1 in various positions;

FIGS. 8 and 9 show torque output from an armature of FIG. 1 at various positions and conditions;

FIG. 10 shows the armature of FIG. 1 as positioned in FIG. 3

FIG. 11 shows the armature of FIG. 1 as positioned in FIG. 4; and

FIGS. 12A to 13C show the declutching mechanism of FIG. 1 incorporated into the door opening/closing system.

### DETAILED DESCRIPTION OF THE PREFERRED EMBODIMENT

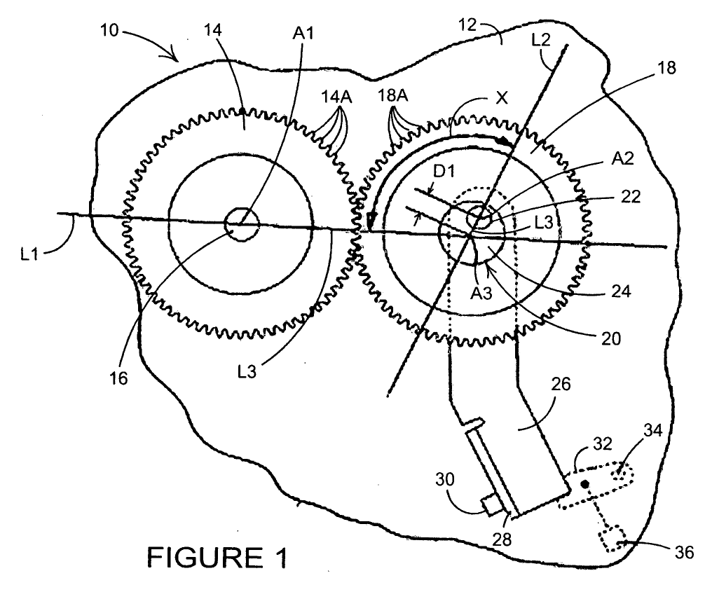

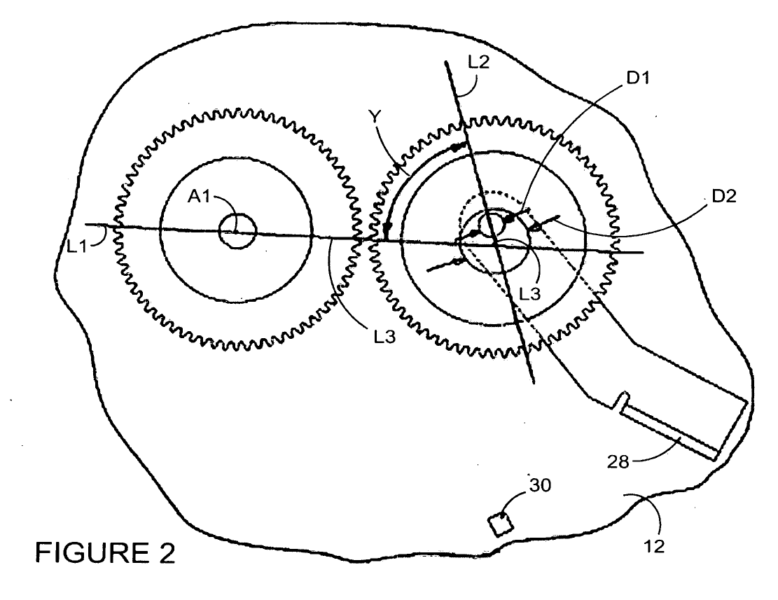

With reference to FIGS. 1 and 2, there is shown a declutching mechanism 10 including a chassis 12 (shown schematically). A first gear 14 is rotatable relative to the chassis 12 about a first gear axis A1. In this case, the first gear axis A1 is defined by a pivot pin 16, which is fixed relative to the chassis 12. Thus, the first gear 14 can rotate about the pivot pin 16.

In further embodiments, an axle could be rotatably fixed relative to the first gear 14 and rotate in a suitable hole in the chassis 12. The first gear 14 includes an array of gear teeth 14A. A second gear 18 is also provided which has an array of gear teeth 18A.

An eccentric arrangement 20 includes a first shaft 22 having a first shaft axis A2 and a diameter D1. The first shaft 22 is non-rotatably fixed to a second shaft 24 having a second shaft axis A3 and a diameter D2. The first shaft axis A2 is offset from the second shaft axis A3 by a distance O1.

The first shaft 22 is longer than the second shaft 24 and projects from each end of the second shaft 24. Each end of the first shaft 22 is mounted in a hole (not shown) in the chassis 12. The eccentric arrangement 20 can therefore selectively rotate about the first shaft axis A2 relative to the chassis 12. Note that the first shaft axis A2 does not move relative to the chassis 12, whereas the second shaft axis A3 can move (as described below) relative to the chassis 12. The second gear 18 is pivotally mounted on the second shaft 24.

A lever 26 is secured rotationally fast to an end of the first shaft 22 remote from the second shaft 24. An end 28 of the lever 26 is made from a magnetic material, for example, steel.

An electromagnet 30 (shown schematically) is capable of holding the first gear 14 in meshing engagement with the second gear 18. Thus, when the electromagnet 30 is being powered, it magnetically attracts the end 28 of the lever 26, thereby holding the lever 26 in the position shown in FIG. 1.

Because the lever 26 is being held in the position shown in FIG. 1, then the second shaft axis A3 is also held in the position shown in FIG. 1. Accordingly, the second gear 18 and the second shaft axis A3 are positioned as shown in FIG. 1.

When the first gear 14 rotates in a clockwise direction, it transmits power to the second gear 18, which in turn rotates in a counter-clockwise direction. Under these circumstances, the profile of the gear teeth 14A and 18A is such as to generate separating forces, which act to move the first gear 14 and the second gear 18 apart. However, because the first gear 14 is rotatable about the first gear axis A1 which is fixed relative to the chassis 12, the second gear 18 is rotatable about the second shaft 24, and the second shaft axis A3 is fixed in the position shown in FIG. 1 because the electromagnet 30 is holding the eccentric arrangement 20 in that position, the first gear 14 and the second gear 18 cannot separate, and therefore power is transmitted from the first gear 14 to the second gear 18.

In the event that it is necessary to declutch the gears 14 and 18, power to the electromagnet 30 can be cut to achieve this. Under these circumstances, once power is cut, then the end 28 is no longer attracted to the electromagnet 30. The separating forces acting through the second shaft axis A3 cause the eccentric arrangement 20 to rotate in a counter-clockwise direction about the first shaft axis A2 to the position shown in FIG. 2. The end 28 is spaced from the electromagnet 30 and that the array of gear teeth 14A have become disengaged from the array of gear teeth 18A. As such, the mechanism has declutched the first gear 14 from the second gear 18 and no further power can be transmitted.

FIG. 1 shows a line L1 drawn through the first gear axis Al and the second shaft axis A3. FIG. 1 also shows a line L2 which is drawn through the first shaft axis A2 and the second shaft axis A3. The lines L1 and L2 together define a third line L3 starting at the first gear axis A1, passing through the second shaft axis A3, and ending at the first shaft axis A2. A line L subtends an angle X at the second shaft axis A3 of 118 degrees.

FIG. 2 shows equivalent lines L1, L2 and L3 when the mechanism has been declutched. In this case, the line L3 subtends an angle Y at the second shaft axis of 65 degrees.

The angle X is greater than 0 degrees and less than 180 degrees. In this case, the angle X is greater than 90 degrees, though in further embodiments this need not be the case. FIG. 2 shows that the angle Y is less than 90 degrees, though in further embodiments this need not be the case.

The embodiments shown in FIG. 1 allow relatively large torques to be transmitted between the first gear 14 and the second gear 18, while only requiring the electromagnet 30 to generate a relatively low holding force. The reasons for this are twofold. First, the profile of the gear teeth 14A and 18A is such that the separating forces (i.e., the radially generated forces) are considerably less than the tangential torque forces. Second, the offset O1 between the first shaft axis A2 and the second shaft axis A3 is less than the effective lever length, i.e., the distance between the first shaft axis A2 and the end 28. The declutching mechanism 10 can be reset by returning the lever 26 to the FIG. 1 position and by powering the electromagnet 30.

As mentioned above, the lever 26 is rotationally secured to an end of the first shaft 22 and by holding the lever 26 in the position shown in FIG. 1, which in turn holds the eccentric arrangement 20 in the position shown in FIG. 1. In further embodiments, the lever 26 can be dispensed with and the eccentric arrangement 20 can be held in the position shown in FIG. 1 by other arrangements.

As mentioned above, when the lever 26 is provided, it is held in place by the magnetic attraction of the electromagnet 30. However, in further embodiments, a pawl 32 could hold the lever 26 in position. FIG. 1 shows in chain dotted outline such a pawl 32 pivotable about a pawl axis 34. The pawl 32 can be rotated counter-clockwise by a release mechanism 36 (shown schematically). Under these circumstances, it is not necessary to make the end 28 of the lever 26 from a magnetic material.

When it is not required to transmit power from the first gear 14 to the second gear 18, then there will clearly be no separating forces. As such, it is not required to power the electromagnet 30, thereby saving electrical power. Once it is required to transmit power from the first gear 14 to the second gear 18, then the electromagnet 30 can be powered to ensure the power can be transmitted from the first gear 14 to the second gear 18 (until such time as it is necessary to declutch the system).

As mentioned above, as shown in FIG. 1, the first gear 14 is a driving gear and the second gear 18 is a driven gear, i.e., power is transferred from the first gear 14 to the second gear 18. Typically, the first gear 14 will be driven by an electric motor. As mentioned above, and by way of example, the first gear 14 is powered in a clockwise direction, thereby driving the second gear 18 in a counter-clockwise direction. When it becomes necessary to declutch the gears 14 and 18 and the second gear 18 moves to the position shown in FIG. 2, not only is it not being driven in a counter-clockwise direction, it is now free to rotate backwards, i.e., free to rotate in a clockwise direction. This is particularly useful to prevent trapped situations. For example, the mechanism could be used to close (or cinch) a vehicle door. If the system detects a trapped situation (such as fingers being trapped in the door), then power to the electromagnet 30 can be cut, and the motor is thereby declutched. By allowing the second gear 18 to rotate backwards in a clockwise direction, this allows the door to be opened, thereby freeing the partially trapped fingers. The system can also be used on window winders to ensure that fingers and the like are not trapped between a rising window glass and a door frame or other fixed structure of the vehicle.

As mentioned above, power is transmitted from the first gear 14 to the second gear 18 by driving the first gear 14 clockwise. In further embodiments, power could be transmitted from the first gear 14 to the second gear 18 by driving the first gear 14 counter-clockwise. Under such circumstances, the separating forces are the same and would still act to declutch the system. In yet further embodiments, the second gear 18 could be used to transmit power to the first gear 14 and the system would still declutch, since the separating forces would be the same.

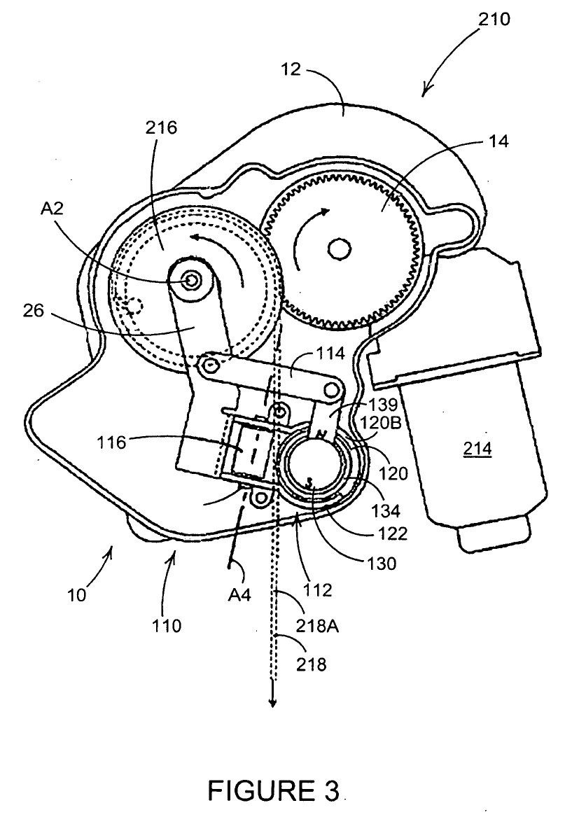

In summary, when the electromagnet 30 is powered, it acts to hold the lever 26, thereby allowing power transmission between the gears 14 and 18. When power to the electromagnet 30 is cut, the separating forces disengage the gears 14 and 18, as shown in FIG. 2. The declutching mechanism 10 can be reset by returning the lever 26 to the FIG. 1 position and powering the electromagnet 30. FIGS. 3 to 5 show a holding/releasing/resetting mechanism 110 that incorporates the declutching mechanism 10 with the electromagnet 30 and also allows resetting of the lever 26.

Thus, with reference to FIG. 3, there is shown the holding/releasing/resetting mechanism 110 including a reluctance motor 112 and a link 114. The lever 26 is pivotally mounted about the axis A2 to the chassis 12 of the holding/releasing/resetting mechanism 110. The lever 26 includes the end 28, and the end 28 is made from a magnetic material, for example, steel.

The reluctance motor 112 includes a coil 116, which defines an axis A4. The coil 116 includes an iron core 118. A first pole piece 120 is connected to one end of the iron core 118, and a second pole piece 122 is connected to the other end of the iron core 118. The first pole piece 120 extends generally perpendicularly to the coil axis A4 and has a first end 120A and a second end 120B. The second pole piece 122 similarly extends generally perpendicularly to the coil axis A4 and has a first end 122A and a second end 122B. The reluctance motor 112 includes an armature 130 which is rotatable about an axis A5 and includes an iron core 132 surrounded by a ring magnet 134. The ring magnet 134 is a permanent magnet having a north pole N and a south pole S. The armature 130 also includes a radially orientated output lever 138. An end 139 of the output lever 138 is pivotally connected to one end of the link 114. An opposite end of the link 114 is pivotally connected to the lever 26. As shown in FIG. 3, the second ends 120B and 122B partially surround the armature 130. The first ends 120A and 122A are in contact with the end 28 of the lever 26.

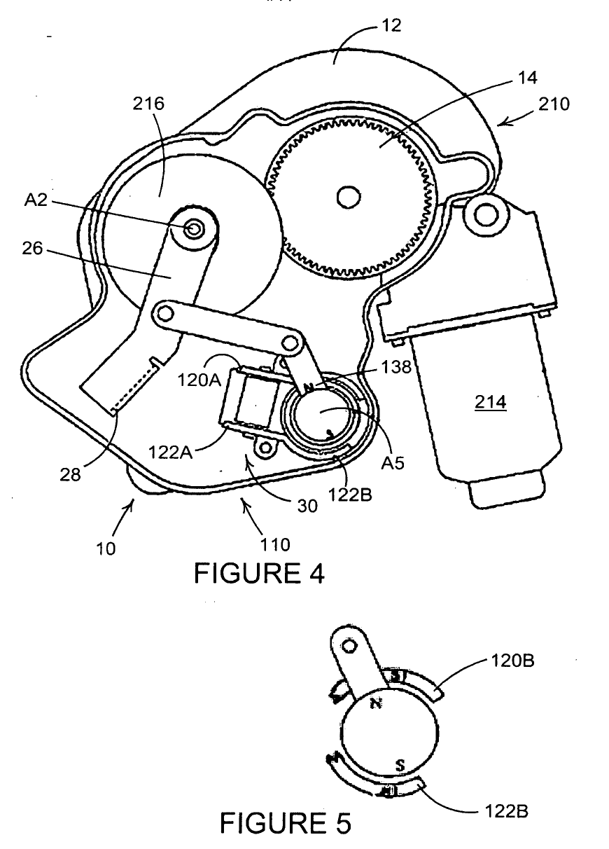

Operation of the mechanism is as follows. In summary, powering of the coil 116 holds the lever 26 in the position shown in FIGS. 1 and 3. When power to the coil 116 is cut, the lever 26 can move to the position shown in FIGS. 2 and 4. Subsequent powering of the coil 116 causes the armature 130 to rotate in a clockwise direction (when viewing FIGS. 3 and 4), returning the mechanism to the position shown in FIGS. 1 and 3.

In more detail, the holding/releasing/resetting mechanism 110 has a first condition, as shown in FIG. 3, in which the coil 116 is powered such that the first pole piece 120 is a south pole and the second pole piece 122 is a north pole. As such, the north pole N of the ring magnet 134 is attracted to the second end 120B of the first pole piece 120, and the south pole S of the ring magnet 134 is attracted to the second end 122B of the second pole piece 122.

Furthermore, powering of the coil 116 causes the first end 120A of the first pole piece 120 to become a south pole and causes the first end 122A of the second pole piece 122 to become a north pole. As such, the first ends 120A and 122A magnetically attract the end 28 of the lever 26 and hold it in the position shown in FIG. 3. The coil 116, the iron core 118 and the first ends 120A and 122A form the electromagnet 30.

Thus, it is possible to hold the lever 26 in the position shown in FIG. 3 against a torque endeavouring to rotate the lever 26 clockwise about the axis A2 when the coil 116 is powered i.e., to hold the lever 26 against the separating forces. However, when power to the coil 116 is cut, the electromagnet 30 no longer holds the end 28. Similarly, the second ends 120B and 122B no longer form magnetic poles and there is therefore less tendency (see below) for the north pole N and the south pole S of the ring magnet 134 to align as shown in FIG. 3. As such, a force attempting to rotate the lever 26 clockwise when viewing FIG. 3 about the axis A2 (i.e., the separating forces) will move the lever 26 to the position shown in FIG. 4 where the end 28 is spaced from the electromagnet 30.

As the lever 26 moves to the position shown in FIGS. 2 and 4, it moves the link 114 which in turn causes the armature 130 to rotate counter-clockwise to the position shown in FIG. 4. The north pole N and the south pole S of the ring magnet 134 are misaligned with the second ends 120B and 122B, respectively, of the first pole piece 120 and the second pole piece 122, respectively.

In order to return the holding/releasing/resetting mechanism 110 to the position shown in FIGS. 1 and 3, it is necessary to repower the coil 116. This will cause the first pole piece 120 to become a south pole and the second pole piece 122 to become a north pole. FIG. 5 shows the moment when the coil 116 has been repowered, but prior to movement of the armature 130. The second end 120B forms a south pole S1, and the second end 120B forms a north pole N1. When this occurs, the north pole N endeavours to align with the south pole S1, and the south pole S endeavours to align with the north pole N1, thereby rotating the armature 130 in a clockwise direction when viewing FIG. 5 to return it to the position shown in FIGS. 1 and 3. As the armature 130 rotates, the output lever 138 moves the link 114 generally to the right as shown in FIG. 4, which in turn causes the lever 26 to rotate counter-clockwise about the axis A2, thereby returning it to the position shown in FIG. 3. Once the end 28 engages the first ends 120A and 122A, then the electromagnet 30 holds the lever 26 in that position.

The holding/releasing/resetting mechanism 110 allows the lever 26 to be selectively held in one position and selectively released, thereby allowing the lever 26 to move to a second position. The holding/releasing/resetting mechanism 110 also allows the lever 26 to be reset to a position wherein the holding/releasing/resetting mechanism 110 can again hold the lever 26.

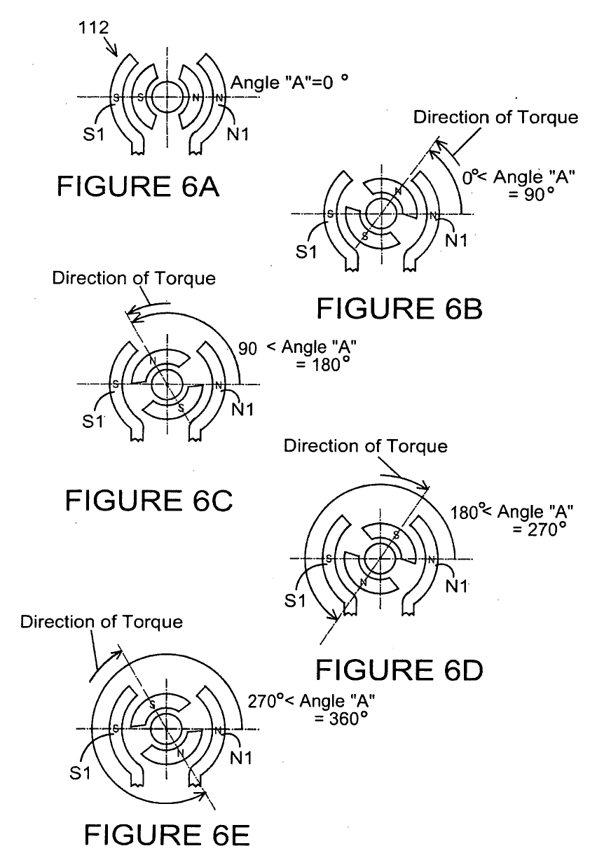

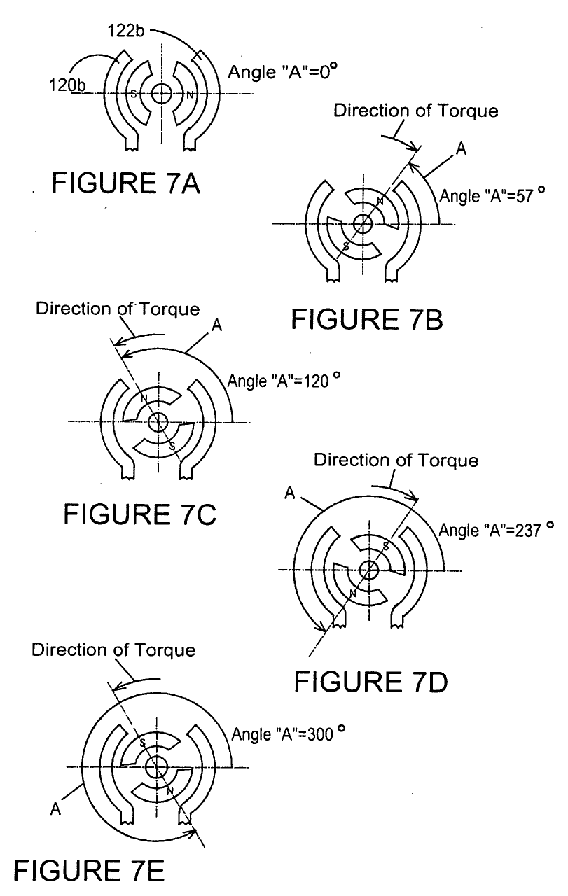

A more detailed explanation of the operation of the reluctance motor 112 is as follows. FIGS. 6A to 7E show various positions of the armature 130 of the reluctance motor 112 prior to assembly of the reluctance motor 112 into the holding/releasing/resetting mechanism 110. As such, it is possible to rotate the armature 130 through 360 degrees. Considering FIG. 7A, the armature 130 is aligned with a nominal datum with the armature north pole on the right and the armature south pole on the left. The armature 130 is thus positioned at zero degrees to the datum. FIG. 7B shows the armature 130 having been rotated through 57 degrees counter-clockwise from the FIG. 7A position. FIG. 7C, 7D and 7E show the armature 130 having been rotated through 120 degrees, 237 degrees and 300 degrees, respectively, from the FIG. 7A position.

Thus, as shown in FIG. 7B, the armature 130 is between 0 and 90 degrees from the FIG. 7A position, as shown in FIG. 7C, the armature 130 is between 90 and 180 degrees from the FIG. 7A position, as shown in FIG. 7D, the armature 130 is between 180 and 270 degrees from the FIG. 7A position, and as shown in FIG. 7E, the armature 130 is between 270 degrees and 360 degrees from the FIG. 7A position.

FIG. 9 shows the torque output of the armature 130 when no current is passing through the coil 116. There are four positions at which the armature 130 produces zero torque, namely 0/360 degrees (i.e., the FIG. 7A position), 90 degrees, 180 degrees and 270 degrees. At the 0/360 degree position and 180 degree position, the armature 130 is in a stable equilibrium position, i.e., a slight displacement of the armature 130 in either a clockwise or counter-clockwise direction from this position will result in it returning to that position. In the 90 degree and 270 degree position, the armature 130 is in an unstable equilibrium position, i.e., a slight displacement from this position in either a clockwise or counter-clockwise direction will result in the armature 130 moving to the 0/360 degree position or to the 180 degree position, as appropriate.

When the armature 130 is positioned between 0 and 90 degrees, the torque output of the armature 130 is negative, and in the present case this represents a torque applied in a clockwise direction to the armature 130 when viewing FIG. 7B. Between 90 and 180 degrees, the torque applied to the armature 130 is counter-clockwise. Between 180 degrees and 270 degrees, the torque applied to the armature 130 is clockwise. Between 270 and 360 degrees, the torque applied to the armature 130 is counter-clockwise.

The torque is a result of the magnetic attraction between the north pole and the south pole of the armature 130 and the magnetic material, e.g., steel from which the second ends 120B and 122B are made. In summary, when the armature 130 is between 0 and 90 degrees or between 270 and 360 degrees, the torque on the armature 130 is such so as to move it towards 0 degrees. However, when the armature 130 is between 90 degrees and 180 degrees or between 180 degrees and 270 degrees, the torque on the armature 130 is such as to rotate the armature 130 to the 180 degree position.

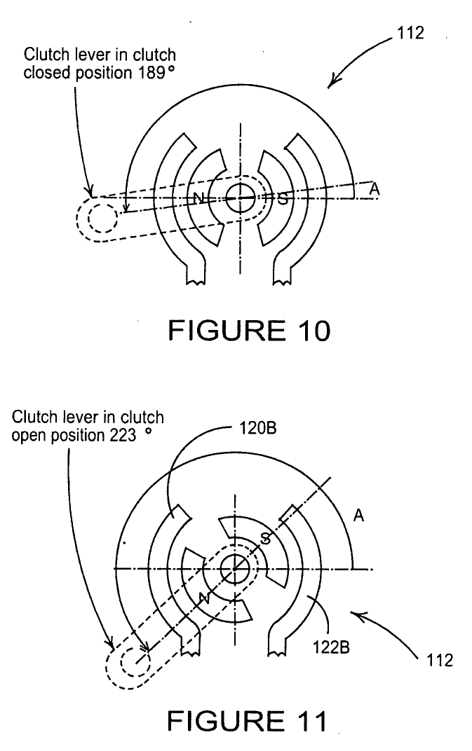

FIG. 10 shows the armature at an angle of 189 degrees, i.e., slightly greater than 180 degrees. This is the position of the armature 130 as shown in FIG. 3. Consideration of FIG. 9 shows that the torque on the armature 130 is slightly negative, i.e., a slight clockwise torque is applied to the armature 130. This clockwise torque acts on the output lever 138, which in turn tends to pull the link 114 generally to the right when viewing FIG. 3. The result of this is that even when there is no current flowing through the coil 116, the end 28 of the lever 26 is held in light engagement with the first ends 120A and 122A. This can be advantageous.

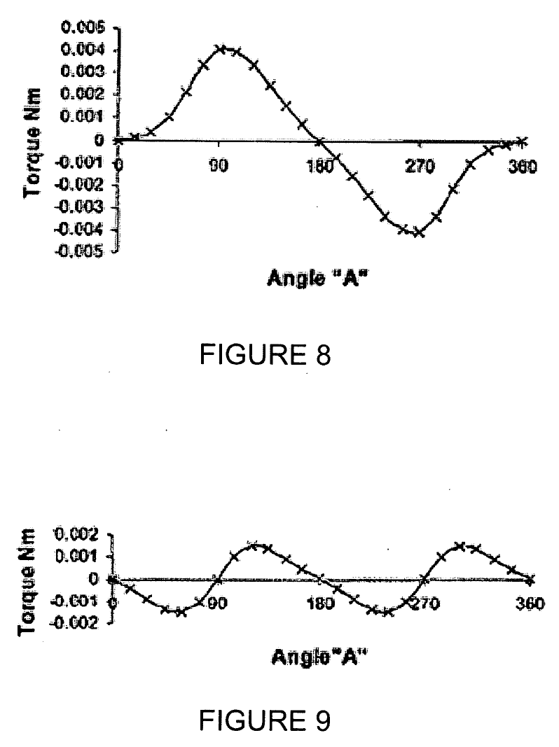

FIGS. 6A to 6E correspond to FIG. 7A to 7E, respectively, except in this case the coil 116 has been powered to generate a south pole S1 at the second end 120B and a north pole N1 at the second end 122B. FIG. 8 shows the corresponding torque on the armature 130 at various angles. A comparison of FIGS. 8 and 9 show that:

a) with the coil 116 powered, the maximum torque generated by the armature 130 is greater than when the coil 116 is not powered, and

b) between 0 degrees and 180 degrees, the torque is always positive (counter-clockwise), and between 180 degrees and 360 degrees, torque is always negative (clockwise) when the coil 116 is powered.

FIG. 11 shows the armature 130 in the same position as shown in FIGS. 4 and 5, namely at an angle of 223 degrees. Consideration of FIGS. 8 shows that when the coil 116 is powered as shown in FIG. 5, the torque applied to the armature 130 is negative (i.e., applied in a clockwise direction) to return the armature 130 to the FIG. 3/10 position.

The declutching mechanism 10 and the holding/releasing/resetting mechanism 110 form part of a vehicle door power opening/closing mechanism 210. A motor 214 selectively drives the first gear 14 in a clockwise or a counter-clockwise direction, depending upon whether it is requires to open or close the door. A gear box mechanism (not shown) connects the output shaft of the motor 214 to the first gear 14.

The second gear 18 is obscured in FIGS. 3 and 4 by a cable drum 216, which is secured rotationally fast to the second gear 18. The cable drum 216 and the second gear 18 both rotate about the second shaft 24. A cable 218 has several turns wound around the cable drum 216 and has a tangential portion 218A positioned tangentially relative to the cable drum 216. A further part of the cable 218 is connected to a slider mechanism on the sliding door to open and close the door.

In the event that a trap situation is encountered when the door is being opened or closed, then power to the electromagnet 30 is cut, resulting in the second gear 18 moving to the position shown in FIG. 2, thereby disengaging the gear teeth 14A and 18A. This then allows the second gear 18 to be rotated backwards i.e., rotated so as to open the door if the trap situation was encountered during closing of the door, or rotated so as to close the door if the trap situation was encountered during opening of the door. The system can be reset using the reluctance motor 112, as described above.

Note that the tension in the tangential portion 218A has an effect on how easily the gears 14 and 18 separate when declutching. Thus, by varying the point around the periphery of the cable drum 216 at which the tangential portion 218A leaves the cable drum 216, the tension in the tangential portion 218A can either pull the gears 14 and 18 together or pull the gears 14 and 18 apart, and this must be taken into consideration when designing the opening/closing mechanism 210.

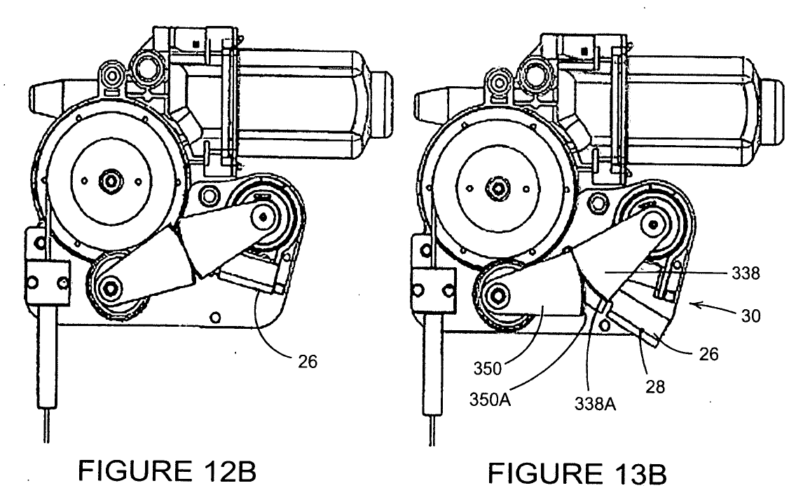

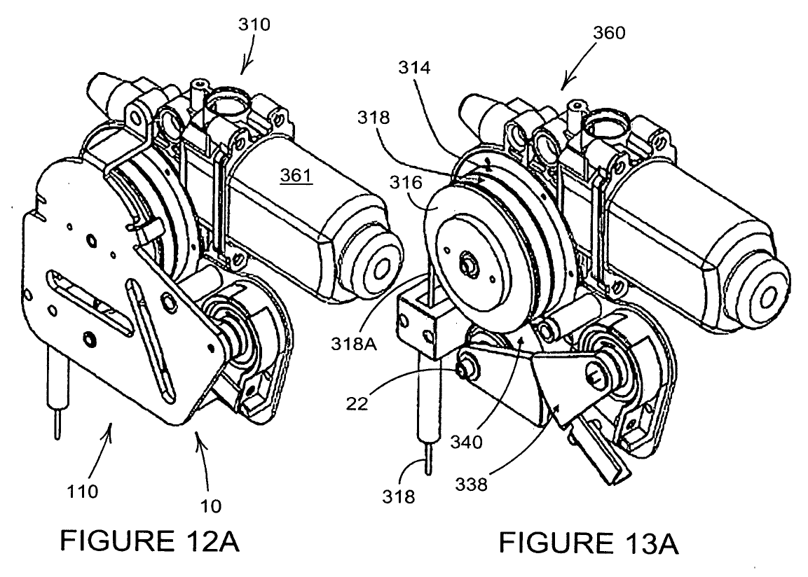

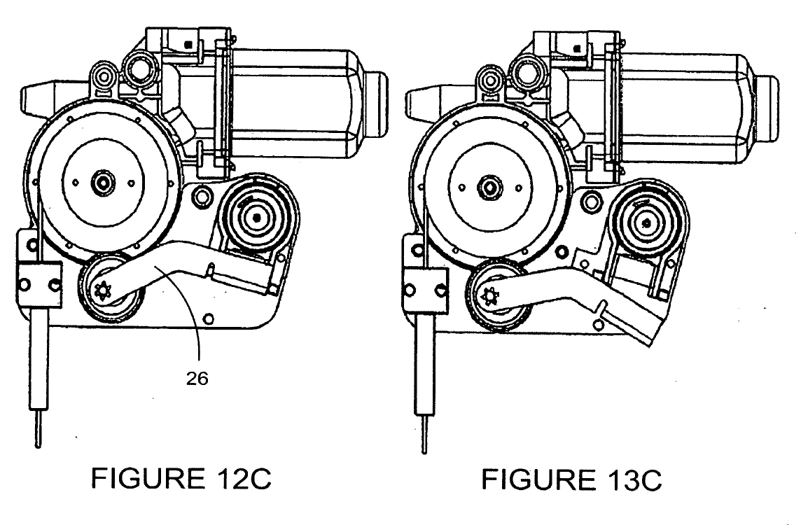

FIGS. 12A to 13C show a second embodiment of a vehicle door power opening/closing mechanism 310 which includes the declutching mechanism 10 and a variant of the holding/releasing/resetting mechanism 110.

In summary, the opening/closing mechanism 310 includes an intermediate gear 340 that operably connects and disconnects an input gear 314 and an output gear 318. The output gear 318 rotates about the same axis as the input gear 314. An armature output lever is in the form of a gear segment 338 which engages with a gear segment 350 attached to the first shaft 22.

In more detail, the motor 361 selectively drives the input gear 314 in a clockwise or counter-clockwise direction, depending upon whether it is required to open or close the door. A gear box mechanism 360 connects the output shaft of a motor 361 to the input gear 314. The input gear 314 includes an array of gear teeth (not shown) around its peripheral edge. An output gear 318 is secured rotationally fast to a cable drum 316 similar to the cable drum 216. The output gear 318 has an array of gear teeth (not shown) around its peripheral edge. The output gear 318 rotates about the same axis as the input gear 314. An intermediate gear 340 has an array of gear teeth (not shown) around its peripheral edge. The intermediate gear 340 is approximately two times wider than either the input gear 314 or the output gear 318. As shown in FIGS. 12A, 12B and 12C, the teeth of the intermediate gear 340 are in meshing engagement with the teeth of both the input gear 314 and the output gear 318 As such, as the input gear 314 is rotated by the motor 361, it causes the intermediate gear 340 to rotate, which in turn causes the output gear 318 to rotate, thereby drawing in or letting out the cable. The intermediate gear 340 can be disengaged (see FIGS. 13A to 13C) from both the input gear 314 and output gear 318 in a manner similar to the way in which the second gear 18 is disengaged from the first gear 14 as mentioned above.

Note that the axis about which the cable drum 316 rotates does not move its position. As such, the tension in the tangential portion 318A of the cable 218 does not affect how the intermediate gear 340 disengages from and reengages the input gear 314 and the output gear 318.

Once the intermediate gear 340 has disengaged from the input gear 314 and the output gear 318, it can be reengaged with them by powering the reluctance motor 112, which causes the gear segment 338 to rotate in a counter-clockwise direction. The gear segment 338 includes an array of gear teeth 338A (shown schematically) which engage with an array of gear teeth 350A of a gear segment 350. The gear segment 350 is secured to the first shaft 22. Thus, as the gear segment 350 is rotated counter-clockwise by the gear segment 338, the end 28 reengages the electromagnet 30. Thus, the gear segments 338 and 350 act to return the declutching mechanism 10 to its engaged position in a manner similar to operation of the armature output lever 138 and the link 114.

Note that the input gear 314 and the output gear 318 have the same diameter, and hence the intermediate gear 340 acts as an idler, i.e., when the intermediate gear 340 is in meshing engagement with both the input gear 314 and the output gear 318, the input gear 314 and the output gear 318 will rotate at the same speed.

In further embodiments, the input gear 314 could be a different diameter to the output gear 318. This would require the intermediate gear 340 to be in two parts, on one side the intermediate gear 340 would have a diameter sufficient to engage with the input gear 314, and on the other side the intermediate gear 340 would have a different diameter suitable to engage the output gear 318. Under these circumstances, when the intermediate gear 340 was engaged with both the input gear 314 and the output gear 318, then the input gear 314 would rotate at a different speed to the output gear 318. The relative diameters of the input gear 314 and the output gear 318 could be such that either the input gear 314 rotated faster than the output gear 318 or alternatively the input gear 314 could rotate slower than the output gear 318.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1 A declutching mechanism comprising:
a chassis;
a first gear rotatable relative to the chassis about a first gear axis fixed relative to the chassis;
a second gear selectively engageable with the first gear;
an eccentric arrangement having a first shaft with a first shaft axis and a second shaft with a second shaft axis offset from the first shaft axis, wherein the first shaft is non-rotatably fixed to the second shaft, the first shaft is selectively rotatably mounted in the chassis, and the second gear is rotatably mounted on the second shaft; and
a holding feature for selectively holding the eccentric arrangement in a first position,
wherein with the eccentric arrangement being held in the first position by the holding feature, the first gear and the second gear are in meshing engagement, and with the eccentric arrangement being released by the holding feature, gear separating forces cause the eccentric arrangement to rotate about the first axis to a second position, thereby disengaging the first gear and the second gear.

2. The declutching mechanism as defined in claim 1 wherein the first shaft has a first diameter and the second shaft has a second diameter, and the first diameter is smaller than the second diameter.

3. The declutching mechanism as defined in claim 1 wherein the second shaft has a diameter and the first axis is positioned within the diameter of the second shaft.

4. The declutching mechanism as defined in claim 1 wherein the second shaft has a diameter and an entirety of the first shaft is positioned within the diameter of the second shaft.

5. The declutching mechanism as defined in claim 1 wherein, with the eccentric arrangement in the first position, a line drawn from the first gear axis to the second shaft axis and to the first shaft axis subtends an angle at the second shaft axis of more than 0 degrees and less than 180 degrees.

6. The declutching mechanism as defined in claim 5 wherein the line subtends the angle at the second shaft axis of more than 90 degrees.

7. The declutching mechanism as defined in claim 5 wherein, with the eccentric arrangement in the second position, the line subtends the angle at the second shaft axis of less than 90 degrees.

8. The declutching mechanism as defined in claim 1 wherein the eccentric arrangement includes a lever rotationally fixed relative to the eccentric arrangement.

9. The declutching mechanism as defined in claim 8 wherein the lever is rotationally fixed to the first shaft.

10. The declutching mechanism as defined in claim 8 wherein the holding feature engages the lever to selectively hold the eccentric arrangement in the first position.

11. The declutching mechanism as defined in claim 10 wherein the holding feature is a pawl.

12. The declutching mechanism as defined in claim 10 wherein the holding feature is an electromagnet.

13. The declutching mechanism as defined in claim 12 including
a reluctance motor having a coil and two pole pieces defining the electromagnet and an armature, wherein the armature is operably coupled to the lever,
wherein the mechanism has a first condition wherein the reluctance motor is powered and the lever engages the two pole pieces to magnetically hold the lever in a first position, and the mechanism has a second condition wherein the reluctance motor is unpowered and the lever is in a second position disengaged from the two pole pieces, and with the mechanism in the second position, powering of the reluctance motor causes the armature to rotate to drive the lever to the first position.

14. The declutching mechanism as defined in claim 13 wherein there are only two pole pieces.

15. The declutching mechanism as defined in claim 14 wherein the coil defines a coil axis and each of the only two pole pieces extends generally perpendicularly to the coil axis, and each of the only two pole pieces have a first end for engaging the lever and a second end which partially surrounds the armature.

16. The declutching mechanism as defined in claim 13 wherein the armature has an output lever operably connected to the lever.

17. The declutching mechanism as defined in claim 16 wherein the output lever is connected to the lever by a link.

18. The declutching mechanism as defined in claim 13 wherein the armature has an output lever in the form of a gear segment which engages a further gear segment, and the further gear segment is connected to the first shaft.

19. The declutching mechanism as defined in claim 1 wherein the second gear is fixed rotationally fast with a cable drum.

20. The declutching mechanism as defined in claim 1 wherein second gear is selectively engageable with a third gear.

21. The declutching mechanism as defined in claim 20 wherein the third gear is rotatable about the same axis as the first gear.

22. The declutching mechanism as defined in claim 20 wherein the third gear rotates at the same speed as the first gear when engaged by the second gear.

23. The declutching mechanism as defined in claim 20 wherein the third gear rotates at a different speed from the first gear when engaged by the second gear.

24. A vehicle door power opening system comprising:
a declutching mechanism for declutching and reclutching components of a transmission path between a vehicle door actuator and a vehicle door, the declutching mechanism including:
a chassis,
a first gear rotatable relative to the chassis about a first gear axis fixed relative to the chassis,
a second gear selectively engageable with the first gear,
an eccentric arrangement having a first shaft with a first shaft axis and a second shaft with a second shaft axis offset from the first shaft axis, wherein the first shaft is non-rotatably fixed to the second shaft, the first shaft is selectively rotatably mounted in the chassis, and the second gear is rotatably mounted on the second shaft, and
a holding feature for selectively holding the eccentric arrangement in a first position,
wherein with the eccentric arrangement being held in the first position by the holding feature, the first gear and the second gear are in meshing engagement, and with the eccentric arrangement being released by the holding feature, gear separating forces cause the eccentric arrangement to rotate about the first axis to a second position, thereby disengaging the first gear and the second gear.
